(19) United States
(12) Patent Application Publication
(10) Pub. No.: US 2019/0065065 A1
(43) Pub. Date: Feb. 28, 2019

(54) DATA PROTECTION METHOD AND STORAGE SERVER

(71) Applicant: Synology Incorporated, Taipei (TW)

(72) Inventor: Kuan-Ling HUANG, Taipei (TW)

(21) Appl. No.: 16/112,782

(22) Filed: Aug. 27, 2018

(30) Foreign Application Priority Data
Aug. 31, 2017 (CN) 201710770703.6

(51) Int. Cl. G06F 3/06

(52) U.S. Cl. CPC G06F 3/065; G06F 3/067; G06F 3/0653; G06F 3/0619

(57) ABSTRACT

A data protection method and a storage server are disclosed. The storage server stores data contents. The data protection method includes: monitoring a change event of at least one protected target of the data contents; calculating a modification amount of the change event when the change event matches at least one monitoring rule with respect to the protected target; and establishing a snapshot of the protected target when the modification amount reaches a monitoring threshold value.

### RELATED APPLICATIONS

This application claims priority to China Application Serial Number 201710770703.6, filed Aug. 31, 2017, which is herein incorporated by reference.

### FIELD

The present disclosure relates to a data protection method and a storage server. More particularly, the present disclosure relates to a data protection method and a storage server that preserve status information of a protected target.

### BACKGROUND

Generally speaking, users can protect the data from loss by backing up data. The conventional backup strategies include, for example, full backup, incremental backup, differential backup or a combination thereof. The full backup strategy backs up all the data every time regardless the data is modified or not. The incremental backup only backs up the data different from the previous backup activity. The differential backup strategy backs up the data different from the first full backup activity. In either strategies described above, the data backup may need a lot of time if the amount of data is very large. This may affect the application programs that are currently in operation.

In order to overcome the issues mentioned above, the snapshot technology is introduced. Since the snapshot may only record the change of the disk sector, the time to take a snapshot may be very short, and thus the snapshot technology has less impact on the application programs that are currently in operation. However, in order to avoid the occurrence of a regional disaster, a remote backup is further required. The remote backup is to transmit the data in a remote server, typically through a Wide Area Network (WAN). In the remote backup, the bandwidth of the network may be affected by the amount of data to be transmitted. Currently, it is hard to estimate the effect on the network bandwidth resulted from the remote backup related to the snapshot. That is, the snapshot and the remote backup of the data may have uncertainty effect on the network bandwidth and the performance of the storage server.

### SUMMARY

An aspect of the present disclosure is to provide a data protection method used in a storage server that stores a plurality of data contents. The data protection method includes the steps outlined below. A change event of at least one protected target of the data contents is monitored. A modification amount of the change event is calculated when the change event matches at least one monitoring rule with respect to the protected target. A snapshot of the protected target is established when the modification amount reaches a monitoring threshold value.

Another aspect of the present disclosure is to storage server, wherein the storage server includes a processor and a storage medium. The processor is configured to execute a monitoring procedure. The storage medium is configured to store a plurality of data contents and a plurality of instructions such that when the processor executes the instructions, the processor is configured for performing the steps outlined below. A change event of at least one protected target of the data contents is monitored. A modification amount of the change event is calculated when the change event matches at least one monitoring rule with respect to the protected target. A snapshot of the protected target is established when the modification amount reaches a monitoring threshold value.

### BRIEF DESCRIPTION OF THE DRAWINGS

The disclosure can be more fully understood by reading the following detailed description of the embodiment, with reference made to the accompanying drawings as follows:

FIG. 1 is a diagram of a usage scenario of a snapshot establishing method in an embodiment of the present disclosure;

FIG. 2 is a diagram of a usage scenario of another snapshot establishing method in an embodiment of the present disclosure;

FIG. 3 is a diagram of an operation environment that allows the data protection system of the present disclosure to be operated therein;

FIG. 4 is a block diagram of a storage server in an embodiment of the present disclosure;

FIG. 5 is a software architecture diagram of a data protection method in an embodiment of the present disclosure;

FIG. 6 is a monitoring rule establishment flow chart of the data protection application in an embodiment of the present disclosure;

FIG. 7 is a monitoring flow chart of the data protection procedure in an embodiment of the present disclosure;

FIG. 8 is a diagram illustrated based on the monitoring flow chart 700;

FIG. 9 is a flow chart of the snapshot establishment performed by the data protection procedure in an embodiment of the present disclosure;

FIG. 10 is a logic block diagram of the monitoring procedure according to a plurality of embodiments of the present disclosure;

FIG. 11 is a detailed block diagram that illustrates the rule module, the monitoring module and the snapshot triggering module in some embodiments of the present disclosure;

FIG. 12 is a detailed block diagram that illustrates the rule module 1050, the monitoring module and the snapshot triggering module in some embodiments of the present disclosure;

FIG. 13 is a scenario of performing the snapshot on the protected target when the data protection method of one or more embodiments in the present disclosure is used;

FIG. 14 is another scenario of performing the snapshot on the protected target when the data protection method of one or more embodiments in the present disclosure is used; and

FIG. 15 is another scenario of performing the snapshot on the protected target when the data protection method of one or more embodiments in the present disclosure is used.

### DETAILED DESCRIPTION

The embodiments hereinafter are described in detail with the accompanying drawings, but the examples provided are not intended to limit the scope covered by the present disclosure. The description of the operation of the structure is not intended to limit the order of its execution. Any structure generated by recombining the components therein and the apparatus having the equivalent functions generated based on the recombination are all covered by the scope of the present disclosure. In order to facilitate understanding, the identical components in the following description will be designated the same reference numerals.

The terms “first”, “second”, . . . , etc. used in the present description do not specifically stand for the order and are not intended to limit the present disclosure. The terms are only used to differentiate the elements or operations having the same technical terms.

Generally speaking, when data protection is performed on the storage systems, a snapshot technology is used to establish a rollback edition in order to recover the protected target (e.g. a file system, a folder or a file) if the data in the target is modified accidentally. The snapshot technology is a technology configured to preserve the status of the data at a certain point of time. For example, the snapshot can be a copy of the original data or can only record the status of a disk sector at a certain time point such that the recovered data can be the same as the original data. The snapshot technology can be performed on any container supported by the file system, for example, can be performed on a logical volume, an entire file system, a directory, one or more files. In one or more embodiments of the present disclosure, the snapshot technology can be implemented by various technologies, such as Copy-on-Write (CoW), Redirect-on-Write (RoW), Split Mirror or Log Structure File.

In other words, the data status of the protected target is established when the snapshot is performed. And, when an accident occurs, the user can use the snapshot to recover the protected target to the previous data status. Take the technology of CoW or RoW as an example, when the snapshot is established, data replication activity does not performed. The data replication is only performed when required in the future. Multiple versions of snapshots can be maintained at the same time. In addition to manually establishing snapshot versions, the snapshot versions can be also established by scheduling. For example, the snapshot versions can be established by the storage system at fixed point of time everyday, or every fixed time interval.

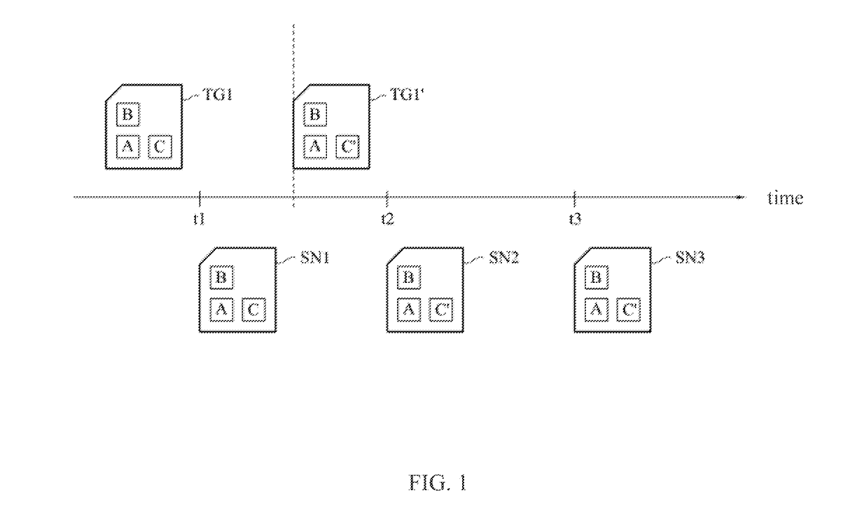

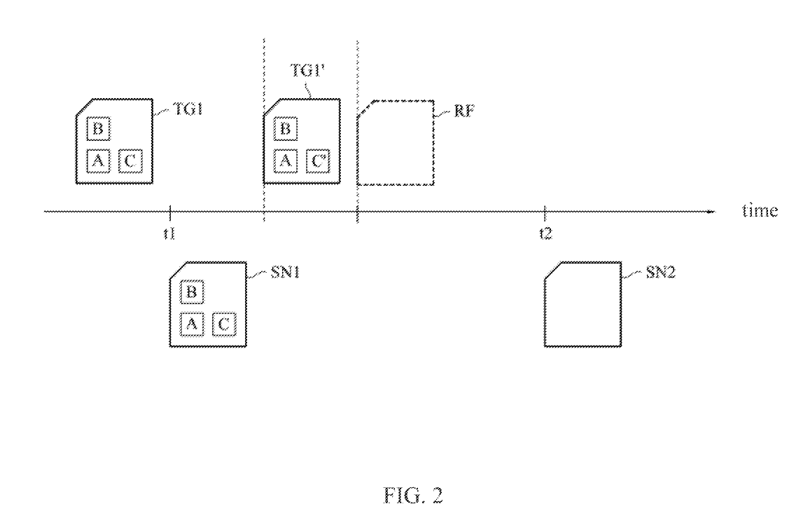

FIG. 1 is a diagram of a scenario of a snapshot establishing method in an embodiment of the present disclosure. FIG. 2 is a diagram of a usage scenario of another snapshot establishing method in an embodiment of the present disclosure. In FIG. 1 and FIG. 2, the target folder TG1 is stored in a storage system, in which the target folder TG1 represents the folder or the directory that is monitored or that a snapshot is going to be performed thereon. The target folder TG1 includes files A, B and C.

In FIG. 1, the storage system is configured to establish a snapshot of the target folder TG1 every fixed time interval (e.g. every 2 hours). For example, the length of the time between the snapshot establishing time points t1˜t2 is 2 hours and the length of the time between the snapshot establishing time points t2˜t3 is 2 hours as well. As illustrated in the diagram, after the snapshot SN1 of the target folder TG1 is established at the time point ti, the file C is modified to become a file C′ during the time interval between the time points t1˜t2. Take file C as a text file for example, after the content of the file C is modified, the modified file C is regarded as a file C′. Since the content of the target folder TG1 is modified, such a modified target folder TG1 becomes the modified folder TG1′. After this, if the modified folder TG1′ is not further modified, and the storage system continuous establishing the snapshots of the modified folder TG1′, the contents of the snapshots at the time points t2˜t3 will be identical. Specifically, the contents of the snapshots SN2 and SN3 all include the files A, B and C′. As a result, the snapshot SN3 is a redundant snapshot that wastes the storage capacity of the storage system.

In FIG. 2, the storage system is configured to establish a snapshot of the target folder TG1 every fixed time interval (e.g. every 24 hours). For example, the length of the time between the time points t1˜t2 to establish the snapshots is 24 hours. As illustrated in the diagram, after the snapshot SN1 of the target folder TG1 is established at the time point t1, the file C is modified to become a file C′ during the time interval between the time points t1˜t2. After this, the user may delete the modified folder TG1′ such that the storage space RF that stores the modified folder TG1′ does not include any file. The snapshot SN2 of the storage system established at the time point t2 is the snapshot of the storage space RF. Though the snapshot SN1 is available for the user to recover the data, the change of the file C′ is lost forever. If the file C′ includes important information, a huge loss is caused.

Accordingly, different from the establishment of the snapshot based on a fixed time schedule, one or more embodiments of the present disclosure use event-based as the reference to trigger the establishment of the snapshot. More specifically, the amount of the change of the target file may be used as the reference to determine whether a snapshot is established to avoid the generation of the redundant snapshot or missing the opportunity to protect important files. Besides, the establishment of the event-based snapshot allows the user or the administration personnel to accurately estimate the effect on the storage system performance as well as the network bandwidth caused by the remote backup related to the snapshot.

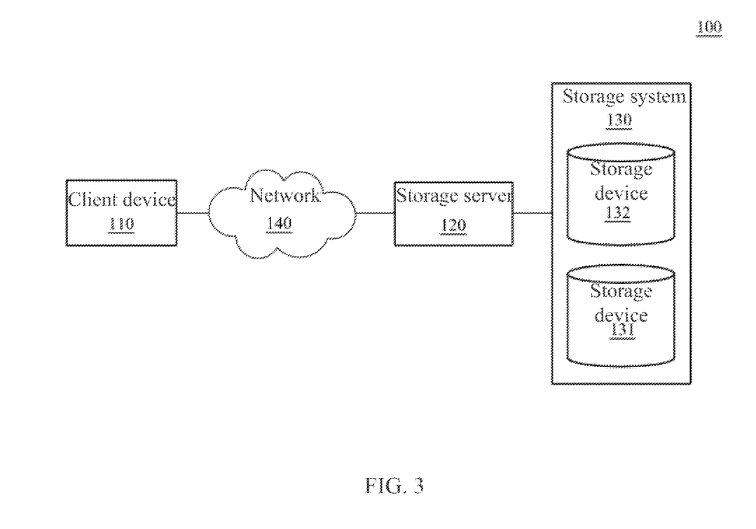

FIG. 3 is a diagram of an operation environment 100 that allows the data protection system of the present disclosure to be operated therein. It is appreciate that the present disclosure is not limited to a specific operation environment. The data protection system of the present disclosure can be operated in various kinds of operation environments. Take FIG. 3 as an example, the operation environment 100 includes a storage server 120 and a client device 110. The data protection system of the present disclosure can be implemented in the storage server 120. The storage server 120 can be used to store various kinds of electronic files in the storage system 130, e.g. in the storage devices 131 and 132 of the storage system 130. The storage server 120 can be connected to the client device 110 through a network 140, in which the network 140 can be, for example, a local area network or a wide area network. The client device 110 can be a notebook, a desktop, a cell phone or other electronic devices equipped with network transmission function. Each of the storage devices 131 and 132 can be a storage device such as a flash memory, a floppy disk, a hard disk, a compact disk, a flash drive or a magnetic tape configured to store a large amount of data.

In an embodiment, the client device 110 has a web browser such that the administration personnel can manage the storage server 120 and the storage system 130 through the web browser. For example, the administration personnel can key a specific web address on the address bar of the browser to access the management interface of the storage server 120. After the related authentication information (e.g. the account and the password) is verified, the administration personnel can have the authority to perform backup, reading, writing and amending the data in the storage system 130. The storage server 120 can perform corresponding operations according to the commands sent from the client device 110.

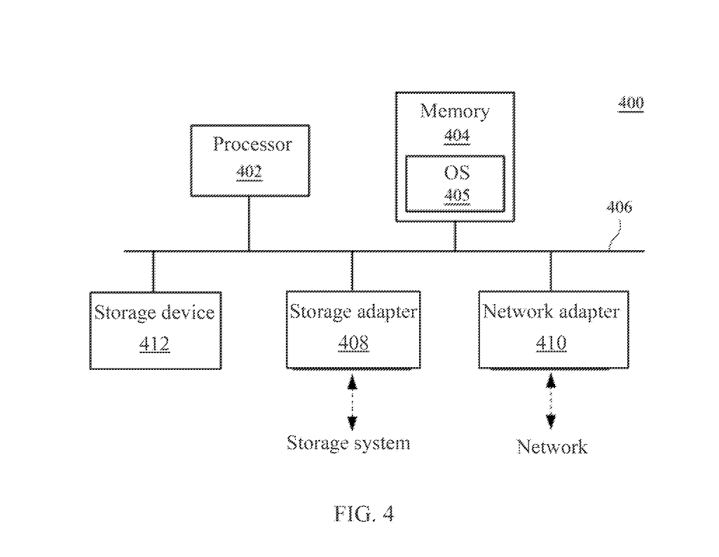

FIG. 4 is a block diagram of a storage server 400 in an embodiment of the present disclosure. The storage server 400 includes one or more processor 402 and memory 404 electrically coupled to an interconnection 406. The interconnection 406 is illustrated conceptually in FIG. 4, in which the interconnection 406 can stand for one or more buses or include any point to point connections, bridging wires and adapters. The interconnection 406 can include such as a system bus, a bus of the peripheral computer interconnect (PCI) family, a small computer system interface (SCSI) bus, a universal series bus (USB), an inter-integrated circuit (I²C) bus and thunderbolt bus.

The processor 402 includes a central processing unit configured to control the operation of the storage server 400. In some embodiments, the processor 402 control the operation of the storage server 400 by executing the software or program codes stored in the memory 404. The processor 402 may include one or more universal microprocessor, digital signal processor (DSP), application specific integrated circuit (ASIC) or programmable logic device (PLD).

The memory 404 of the storage server 400 can be a random access memory, a read-only memory, a flash memory or a combination thereof. In an actual usage scenario, the memory 404 can be used to store an operating system (OS) 405 of the storage server 400.

The storage adapter 408 and the network adapter 410 are also electrically coupled to the processor 402 through the interconnection 406. The storage adapter 408 allows the storage server 400 to access the storage system (e.g. the storage system 130 illustrated in FIG. 3). The storage adapter 408 can be a SCSI adapter or a fiber channel adapter. The network adapter 410 provides the storage server 400 the function of communication with remote devices. The network adapter 410 can be an Ethernet adapter. In some embodiments, the storage server 400 can also include a local storage device 412.

It is appreciated that the client device 110 can also include at least part of identical components in the storage server 400. For example, the client device 110 also includes a processor and a memory that exchange or transmit information through an interconnection.

The operating system 405 of the storage server 400 can be used to execute related operations of access, writing, backup and snapshot of data. The operating system 405 can be implemented by a plurality of microkernels, by an application program that can be operated on a universal operating system (e.g. Linux or Windows NT) or by a universal operating system configured to manage the storage applications. According to one or more embodiments, the memory 404 stores the operating system 405 and the related storage application programs such that the processor 402 is able to monitor a change event of one or more protected target of the data contents stored in the storage server 400 and trigger the event-based snapshot establishment.

In one or more embodiments, the event can be a specific change of a file. For example, the event can be the change of the file in the protected target that matches an established monitoring rule. The establishing of the monitoring rules is related to the monitoring capability that the kernel of the operating system 405 can support. For example, the Linux kernel has the function to monitor a file or a folder and notify the application program of the change applied thereon. More specifically, take the Linux operating system as an example, the monitoring of the file or the folder may include the conditions of adding a file or a folder, deleting a file or a folder, modifying a file, moving in a file or a folder, moving out a file or a folder, writing a file or a folder, renaming a file or a folder or modifying an attribute of a file or a folder.

In an implementation, the monitoring of the file can be implemented by the file change notification system of Linux, e.g. the inotify module, the dnotify module or the fanotify module. Each of the modules can provide respective system call interface to the application programs of the user space. The monitoring categories and the abovementioned modules are described more detail below.

inotify module: any file is allowed to be monitored, and the monitoring categories may include, for example, the accessing of a file, establishing a file in a monitored folder, deleting a file in a monitored folder, deleting a monitored target, modifying a file, moving a file out from a monitored folder, moving a file into a monitored folder, renaming a file and modifying an attribute of a file or a folder.

dnotify module: only the change of a file under a specific directory can be monitored, and the monitoring categories may include, for example, accessing a file under the directory, modifying a file under the directory, establishing a file under the directory, deleting a file under the directory, renaming a file under the directory, moving a file under the directory and modifying an attribute of a file under the directory.

fanotify module: the change of the whole file system can be monitored, and the monitoring items may include, for example, accessing a file or a directory, opening a file or a directory and modifying a file.

It is appreciated that the above embodiments are merely examples. The present disclosure is not limited to Linux operating system. If Windows operating system is used, specific function library for monitoring files can be used to implement the file-monitoring function, e.g. FileSystemWatcher. When a directory or a file in a directory is modified, the change of the file system can be observed and the application program of the user space can be informed.

In an implementation, the monitoring rules provided by the application programs in the user space are related to the monitoring capability that the kernel of the operating system 405 can support. For example, the inotify module can monitor the deleting of a file, so the application program can provide the monitoring of the deleting of the file. The monitoring rules can be, for example, established to trigger the snapshot when the file is deleted for more than 10 hours.

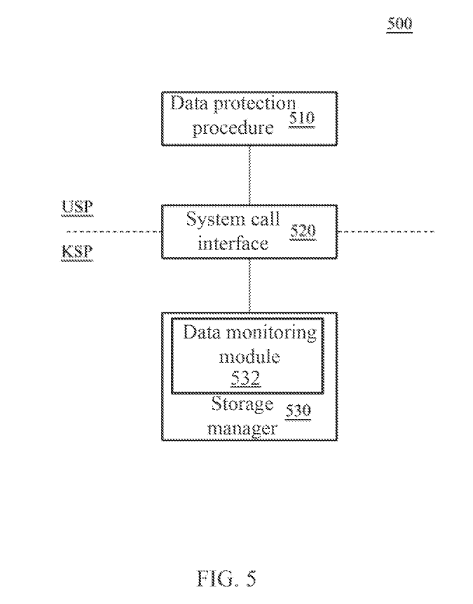

In order to have a better understanding, one or more embodiments of the present disclosure are described in accompany with diagrams. FIG. 5 is a software architecture diagram 500 of a data protection method in an embodiment of the present disclosure.

As illustrated, the software architecture diagram 500 includes a user space USP and a kernel space KSP. In an embodiment, the kernel space KSP is a virtual space disposed in the memory to be used by the kernel when the Linux kernel is loaded. Under the operation of some programs, the data has to be read to the memory so as to be used before the processor performs processing. The kernel space KSP is a memory space to make sure the Linux kernel load the hardware resources without being interrupted or occupied by other programs.

The user space USP is the data space for the user to perform modification or editing. Some application programs for controlling and managing the hardware devices are operated in the user space USP. In some examples, daemons are also operated in the user space USP. Take FIG. 5 as an example, the user space USP includes a data protection application 510 (e.g. a snapshot application). The data protection application 510 is in charge of functions of the establishment of the monitoring rules and the triggering of the snapshot. In an embodiment, the data protection application 510 further provides the ability of remote backup (e.g. a snapshot and replication procedure). Moreover, the establishment of one or more protected targets can be accomplished by the data protection application 510. The establishment of one or more monitoring rules with respect to each protected target can also be accomplished by the data protection application 510. When the change of the file in the protected target matches the established monitoring rules (the occurrence of the change event), the data protection application 510 preserves the status information of the file of the protected target when the change event occurs through snapshot. Accordingly, the data protection application 510 of the present disclosure avoids the generation of the redundant snapshots that waste the storage space. Besides, the data protection application 510 of the present disclosure can guarantee that the amount of the change of the file between each of two editions of the snapshot is the same. If the data protection application 510 has the remote backup function (take the incremental backup as the remote back as an example), the time required to transmit the backup file after the snapshot is performed can be determined. Thus, the administration personnel can accurately estimate the effect on the efficiency and the network bandwidth caused by the snapshot and the action of transmitting the data backup to the remote terminal after the snapshot. Appropriate amount of resource can be distributed to the data protection application 510 and sufficient amount of resource can be preserved for the other application programs.

The kernel space KSP may include a storage manager 530 that is in charge of the functions related to data access. The storage manager 530 can be a microkernel in the kernel space KSP and can be operated in some universal operating systems (e.g. Linux or Windows NT). Take Linux as an example, the storage server 530 can include a plurality of software layers such as a virtual file system (VFS), a file system or a volume manager. The file system can be a B-tree file system (Btrfs) or a fourth extended file system (ext4). One or more file systems can be used depending on different application requirements. The virtual file system can communicate with different file systems to provide a standard interface to the application programs in the user space USP (e.g. the data protection application 510). The volume manager is used to manage the disk partitions of the storage device. In an embodiment, the data protection application 510 can perform snapshot through the file system. However, the present disclosure is not limited thereto. In other embodiments, the data protection application 510 can perform snapshot through the volume manager or other software layers (not limited to the software layers mentioned in the present disclosure).

The storage manager 530 further includes a notifier 532 configured to monitor the change of the data of the protected target. In one or more embodiments, the notifier 532 can be implemented by various kinds of monitoring modules. Take Linux operating system as an example, the notifier 532 can be implemented by iontify module, fanotify module or dnotify module. Take the Windows operating system as an example, the monitoring module 532 can be implemented by FileSystemWatcher.

In an implementation, in addition to the software layers mentioned above, the storage manager 530 may include other software layers, such as the network protocol layer and the network file system layer, to provide the network accessing function. The storage manager 530 may include the storage device driver layer to communicate with the physical storage device in the bottom layer.

In an embodiment, the software architecture diagram 500 may include one or more system call interface 520. Each of the various function modules described above may include a corresponding system call interface 520 to perform communication to connect at least part of the software layers between the data protection application 510 and the storage manager 530. It is appreciated that the above description is only an example of the user space USP and the kernel space KSP. The present disclosure is not limited thereto. The implementation of each of the steps can be adjusted according different actual system environments.

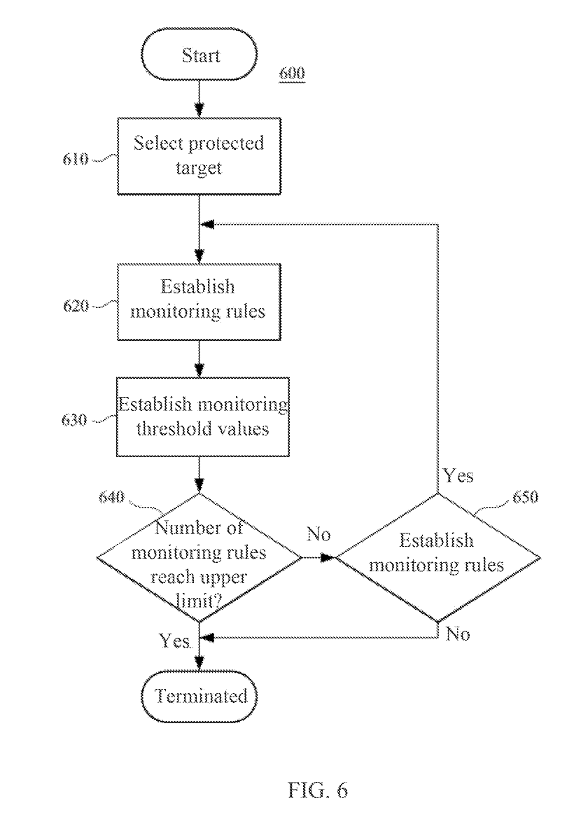

In order to understand and implement the cooperation between the whole data protection application 510 and the kernel space, the description is further made in accompany with a flow chart in the following paragraphs. FIG. 6 is a monitoring rule establishment flow chart 600 of the data protection application in an embodiment of the present disclosure. As illustrated, in step 610, the protected target is selected. The selection of the protected target can be implemented by the user interface of the data protection application. After receiving the selection command from the user, the data protection application temporarily stores the selection information in the memory (e.g. the memory 404 in FIG. 4). In an embodiment, the protected target can be a folder or a shared folder. The shared folder is the folder that can be accessed together by a plurality of users through the network with the authority. In another embodiment, the protected target can be one or more files.

In an embodiment, after the selection of the folder or the shared folder is completed, one or more subfolders or one or more files can be selected. Such a folder or file can be the subfolder or the file under the protected target in step 610. In an embodiment, the step of further selection of the subfolder or the file is optional after step 610.

In an embodiment, when the protected target is at least one folder (for example, when at least two folders are included, the description is exemplarily made by using the terms of a first subfolder and a second subfolder), the processor (e.g. the processor 402 in FIG. 4) is configured to receive the at least one subfolder selection information of the at least one folder and store the at least one subfolder selection information in a data structure. The at least one subfolder selection information includes a first subfolder path corresponding to the first subfolder and/or a second subfolder path corresponding to the second subfolder.

In an embodiment, when the protected target is at least one file (for example, when at least two files are included, the description is exemplarily made by using the terms of a first file and a second file), the processor (e.g. the processor 402 in FIG. 4) is configured to receive the at least one file selection information of the at least one folder and store the at least one file selection information in a data structure. The at least one file selection information includes a first file path corresponding to the first file and/or a second file path corresponding to the second file.

In step 620, the monitoring rules are established. The establishing of the monitoring rules relate to the monitoring capability that the kernel of the operating system 405 can support. Take the inotify module of the Linux operating system as an example, the application program can provide the user the monitoring rules for monitoring the deleting of a file because the inotify module can monitor the deleting of a file in a folder. For example, the user can establish a rule to trigger the snapshot once the number of the files deleted in the protected target exceeds 10. Furthermore, take the fanotify module of the Linux operating system as an example, the user cannot establish the monitoring rules related to the renaming of the file when the operating system uses the fanotify module to monitor the files since the fanotify module does not support the monitoring the attribute change of the file (e.g. renaming of the file). In an implementation, when the inotify module is used to monitor the files, the monitoring rule r can be selected from the set formed by the rules R supported by the inotify module and can be expressed by:

r∈R={create,delete,modify,move_from, move_to,attrib}

The parameter “create” stands for the monitoring of the creation of the file or the folder in the protected target. The parameter “delete” stands for the monitoring of the deletion of the file or the folder in the protected target. The parameter “modify” stands for the monitoring of the file change, including the writing or the amendment. The parameter “move_from” stands for the monitoring of the file or the folder moved from the protected target. The parameter “move_to” stands for the monitoring of the file or the folder moved in the protected target. The parameter “attrib” stands for the monitoring the attribute change of the file or the folder in the protected target. The protected target described herein can be a file or a folder (including a shared folder).

In an embodiment, at least one monitoring rule applied to the protected target can be established through the network. More specifically, the client device (e.g. the client device 110 in FIG. 3) can connect to the storage server (e.g. the storage server 120 in FIG. 3) through the network, and once the storage server 120 verified the client device (e.g. through the user account and password), the client device may have authority to operate the data protection application (e.g. the data protection application 510 in FIG. 5). In an implementation, the data protection application can be a web application (Webapp) that can be operated through the web browser in the client device 110. In some other embodiments, the client version of the data protection procedure can be installed on the client device 110 (e.g. a tablet personal computer or a cell phone). After inputting the verification information through the client version, the establishment of the monitoring rules applied to the protected target in the storage server 120 can also be accomplished.

In an embodiment, the protected target can include a plurality of folders, e.g. the first subfolder and the second subfolder. The data protection application can be used to select the first rule corresponding to the first subfolder and the second rule corresponding to the second subfolder, e.g. the monitoring of the deletion of the file in the first subfolder and the monitoring of the addition of the file in the second subfolder.

In another embodiment, the protected target can include a first file and a second file. The data protection application can be used to select the first rule with respect to the first file and the second rule with respect to the second file, e.g. the monitoring of the renaming of the first file and the monitoring the attribute change of the second file.

In step 630, the monitoring threshold values corresponding to the monitoring rules are established for each of the protected target. More specifically, the user interface of the data protection application can be configured to establish the threshold values. After the processor (e.g. the processor 402 in FIG. 4) receives the threshold value establishing command from the data protection application, the monitoring can be performed on the protected target according to the threshold value establishing command. When the events matches the monitoring rules in the protected target, and the events also match the established monitoring threshold values, the processor 402 performs the corresponding operation on the protected target, e.g. snapshot.

For example, when the protected target includes the first subfolder and the second subfolder, the following monitoring rules and the monitoring threshold values can be established through the data protection application: performing the snapshot on the first subfolder (i.e. preserving the status information of the first subfolder at this time point) when 10 files in the first subfolder are deleted (the monitoring threshold value is 10); performing the snapshot on the second subfolder (i.e. preserving the status information of the second subfolder at this time point) when 20 files in the second subfolder are deleted (the monitoring threshold value is 20).

In an embodiment, when the protected target includes a first file and a second file, the monitoring rules and the monitoring threshold values can be established through the data protection application: when the first file is renamed once (the monitoring threshold value is 1), the snapshot is performed on the first file (i.e. preserving the status information of the first file at this time point); when the amount of bits of the change of the second file exceeds 500 KB (the monitoring threshold value is 500 KB), the snapshot is performed on the second file (i.e. preserving the status information of the second file at this time point).

In an embodiment, the step 630 may be optional. For example, the data protection application can establish predetermined threshold values corresponding to each of the monitoring rules. For the monitoring rules related to the change of the file, a default value of 10 may be set such that when the number of the change exceeds 10 times, the snapshot is performed. For the monitoring rules related to the attribute of the file, a default value of 1 may be set such that when the number of the change of the attribute reaches one, the snapshot is performed. In an implementation, the step 630 can be customized under the user's request.

In step 640, whether the number of the monitoring rules is larger than an upper limit is determined. If the number of the monitoring rules is larger than the upper limit, the monitoring rule establishment flow chart 600 is terminated. If the number of the monitoring rules is not larger than the upper limit, the flow goes to step 650. In an embodiment, the number of the monitoring rules with respect to the protected target can be one or more than one. For example, the monitoring rules for a certain folder can include: (1) The number of the changes of the content of the file in the folder exceeds 10; (2) The number the attribute changes of the file in the folder exceeds 10. In an implementation, the snapshot can be performed on the protected target under the occurrence of the union of the rule (1) and rule (2), i.e. either the condition of the rule (1) or rule (2) is met. In some other embodiments, the intersection of a plurality of monitoring rules can be used. For example, For example, the monitoring rules for a certain folder can include: (1) The number of the changes of the content of the file in the folder exceeds 10; (2) The modified amount of bits of the change of the file in the folder exceeds 100 KB. The snapshot is performed on the protected target only when both of the rule (1) and rule (2) are met.

As illustrated in steps 640-650, the data protection application can establish an upper limit of the number of the monitoring rules and determine whether the number of the monitoring rules with respect to each of the protected target reaches the upper limit. If the upper limit is reached, the monitoring rule establishment method is terminated. If the upper limit is not reached, the step 650 is performed to receive another monitoring rule. Accordingly, the data protection application can avoid consuming too much resource of the storage server 120 by establishing excessive number of the monitoring rules. In an embodiment, the steps 640-650 may be optional. In an implementation, the upper limit of the number of the monitoring rules can be directly set to be 1 to simplify the flow.

It is appreciated that the various functions and steps of the data protection application described above can be executed by the processor (e.g. the processor 402 in the storage device 400 in FIG. 4) after accessing the program code of the data protection application.

Through the steps described above, the processor can store the monitoring rules and the parameters thereof including the monitoring threshold values that each of the protected target corresponds in a database to finish the establishment of the monitoring rules.

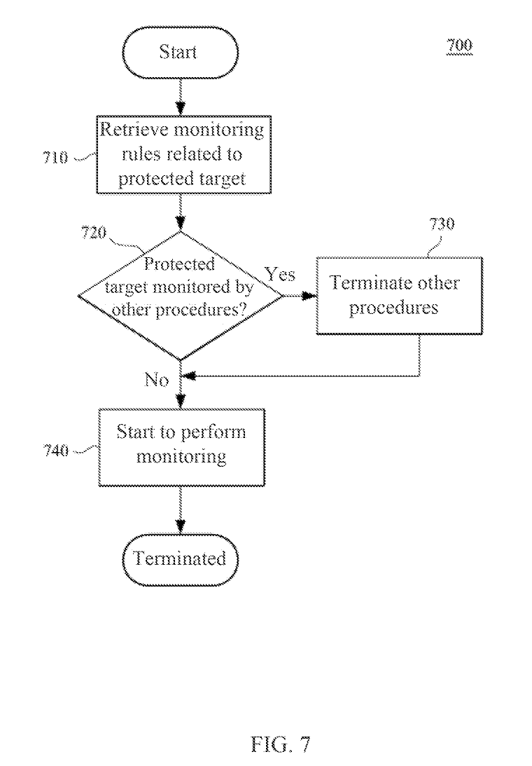

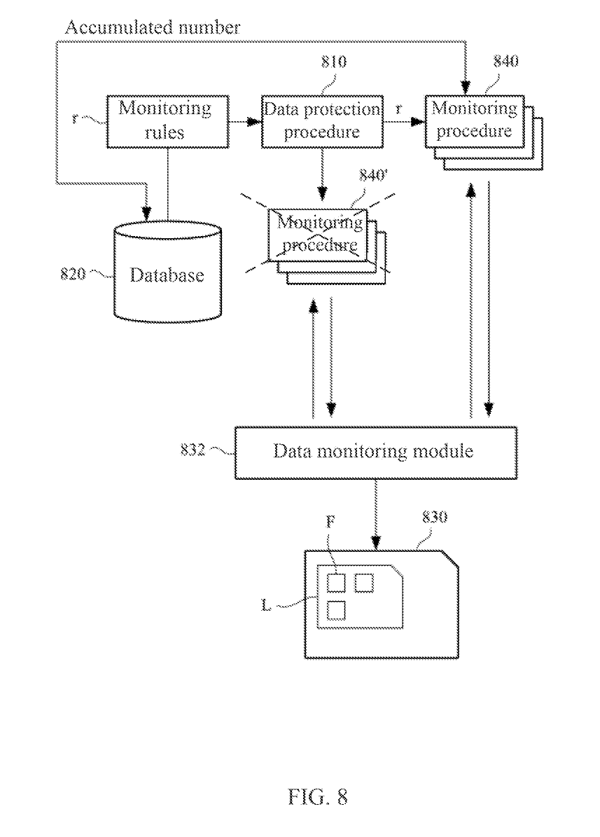

After finishing establishing the rules with respect to the protected target and storing the rules in the database, the data protection application 510 (e.g. the snapshot application or the snapshot and replication application, in which the present disclosure is not limited thereto) in the storage server (e.g. the storage server 120 in FIG. 3 or the storage server 400 in FIG. 4), can perform monitoring on the protected target. In order to have a better understanding on the principle of how the data protection application 510 performs monitoring on the protected target, the reference is now made to FIG. 7 and FIG. 8. FIG. 7 is a monitoring flow chart 700 of the data protection application in an embodiment of the present disclosure. FIG. 8 is a diagram illustrated based on the monitoring flow chart 700.

In step 710, the monitoring rules r related to the protected target 830 is obtained. More specifically, after establishing the monitoring rules r related to the protected target, the establishing parameters are stored in the database 820. In an embodiment, the establishing parameters may include the following information: the monitored subfolder parameter L, the monitored file parameter F, the category parameter of the monitoring rules r, the threshold value parameter T related to the category of the monitoring rules, the number parameter of the change file m and the parameter regarding the modified amount of bit change related to the monitored file b. In an embodiment, the categories of the parameters included in the monitoring rules r is expressed as r=[L, T, r, F, m, b]. It is appreciated that the categories included in the formula is merely an example. The categories of the parameters included in the monitoring rules r can be adjusted according to actual needs.

When the data protection application 810 performs monitoring on the protected target 830, the monitoring rules r related to the protected target 830 are retrieved from the database 820. Furthermore, with respect to the protected target 830, the data protection application 810 activates one or more monitoring procedure D according to the monitoring rules r. For example, the data protection application 810 activates a monitoring procedure 840 for each of the monitored subfolder (retrieved from the information of the parameter L) and for each of the monitored file (retrieved from the information of the parameter F) in the protected target 830 if the monitoring rules r=[L, T, r, F, m, b]. The monitoring procedure 840 can be a daemon and can be implemented in the user space USP or the kernel space KSP. More specifically, if the parameter r includes two monitoring categories including renaming of a file and deleting of a file, in which the parameter T has the threshold value of 2 for the renaming and the threshold value of 1 for the deleting of the file, the data protection application 810 performs snapshot on the folder L when 2 files are renamed and 1 file is deleted in the folder L in the protected target 830. Further, if the parameter b has the threshold value of 100 KB for the modified amount of bits of the change of the file, the snapshot is performed on the file F when the modified amount of bits of the change of the monitored file F in the folder L reaches 100 KB.

After retrieving the monitoring rules r related to the protected target 830, the data protection application 510 further determines whether the protected target 830 is monitored by another monitoring procedure 840′ (step 720). If the data protection application 510 discovers that the protected target 830 is monitored by another monitoring procedure 840′, the monitoring procedure 840′ is terminated (step 730) since the rules are updated. If the protected target 830 is not monitored by another monitoring procedure 840′, the data protection application 510 starts to perform monitoring (step 740). Accordingly, the condition of monitoring conflict can be avoided if two monitoring procedures using conflicted monitoring rules to monitor the same protected target 830.

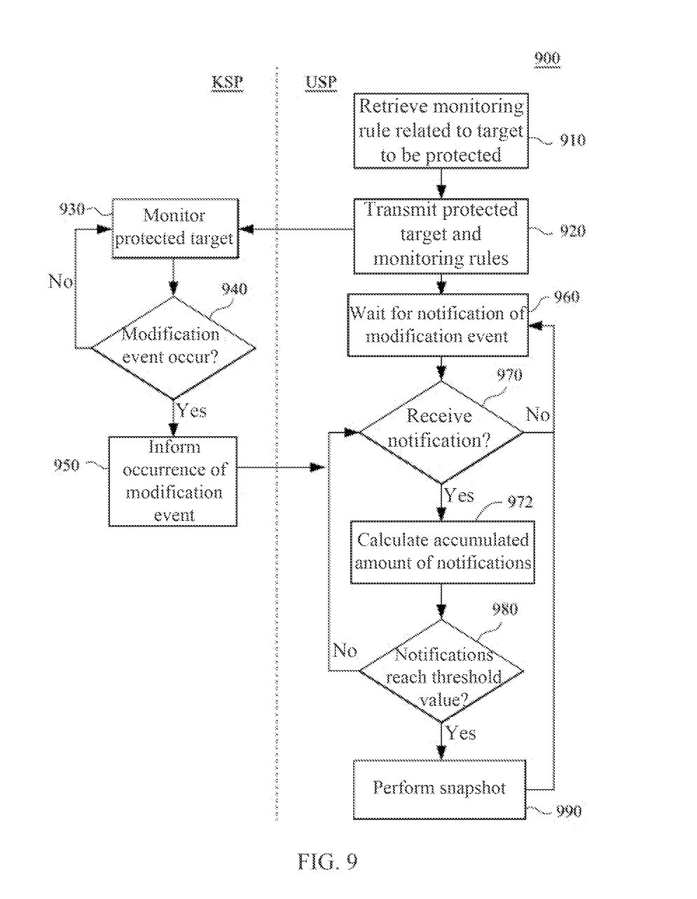

FIG. 9 is a flow chart 900 of the snapshot establishment performed by the data protection application 510 in an embodiment of the present disclosure. FIG. 9 further describes how the data protection application establishes the snapshot according to the degree of the change of the data in the protected target. Reference is now made to FIG. 8 and FIG. 9 at the same time. Simply speaking, the data protection application 810 uses the program interface provided by the notifier 832 in the kernel space to inform the file system of the current monitoring categories performed on the file or the folder in the protected target 830. When the event occurs on the file or the folder and matches the monitoring categories, the notifier 832 informs the monitoring procedure 840 in the user space USP. Under such a condition, the monitoring procedure 840 stores the accumulated number of the notification to the database 820 and determines whether the accumulated number exceeds or reaches the defined monitoring rules r. If the accumulated number exceeds or reaches the defined monitoring rules r, the establishment of the snapshot is triggered.

In order to have a better understanding, the operation detail of each step in FIG. 9 is further described in the following paragraphs. Reference is now made to FIG. 8 and FIG. 9. In step 910, the monitoring rules r related to the protected target 830 are retrieved. Since step 910 is similar to step 710, the detail is not described herein.

In step 920, transmit the protected target 830 and the monitoring rules r with respect to the protected target 830. In step 930, monitor the protected target 830. In an implementation, take Linux file system as an example, the monitoring procedure 840 informs the virtual file system (VFS) in the kernel space KSP of the protected target 830 and the monitoring rules r with respect to the protected target 830. The virtual file system may call the monitoring modules (inotify module, fanotify module or dnotify module) to perform monitoring on the protected target 830. It is appreciated that although the FIG. 9 clearly defines the steps that may be respectively executed in the kernel space KSP and the user space USP, the present disclosure is not limited thereto. These steps may be executed by either in the kernel space KSP or the user space USP in some embodiments.

In step 940, determine whether the change event occurs. In step 950, inform the occurrence of the change event. In an implementation, take Linux file system as an example, the change event (e.g. the adding or deleting the file F) in the specific folder F in the protected target 830 can be monitored by the inotify module. Besides, the inotify module can also monitor the change event in the protected target 830 (e.g. the adding or deleting of the file F). When the change event that matches the monitoring rules r occurs in the monitored folder L or the file F in the protected target 830, the inotify module informs the monitoring procedure D in the user space USP of the occurrence of the change event.

Regarding the user space USP, after transmit the monitoring rules to the notifier 832 (e.g. inotify module) in the kernel space KSP in step 920, the flow goes to step 960 to wait for the notification of the change event, i.e. the monitoring report of the notifier 832. More specifically, after the protected target 830 and the monitoring rules r with respect to the protected target 830 are transmitted to the file system in the kernel space KSP, the monitoring procedure 840 in the user space USP waits for the file system to notify whether the change event that matches the monitoring rules in the protected target 830 occurs. If the notification of the occurrence of the change event is received (step 970), the flow goes to step 972 to calculate the accumulated amount of notification and the monitoring procedure 840 stores the accumulated amount of notification in the database 820. If the accumulated amount of notification reaches the threshold value (step 980), the snapshot is performed (step 990).

In an exemplary embodiment, assuming the monitoring procedure 840 monitors the folder L in the protected target 830, and the monitoring rules r include the deleting of the file in which the threshold value of the deleting is 3, then when the file F in the folder L is deleted, the notifier 832 informs the monitoring procedure 840 about the occurrence of the file deleting event every time. The monitoring procedure 840 accumulates the number of the file deleting event. When the number of the deleting event reaches three times, the snapshot to the folder L is performed.

In another exemplary embodiment, assuming the monitoring procedure 840 monitors the file F in the protected target 830, and the monitoring rules r include the change of the file and the monitoring threshold value of the modified amount of bits of the change is 100 KB, then when the file F in the folder L is modified, the notifier 832 informs the monitoring procedure 840 of the occurrence of the file change event. The monitoring procedure 840 calculates the amount of bits of every change of the file F and records the calculation in the database 820. When the amount of bits of the change reaches 100 KB, the monitoring procedure 840 performs the snapshot on the file F.

In an embodiment, the monitoring procedure 840 described above can be implemented in the kernel space KSP, i.e. the step in FIG. 9 can be implemented in the kernel space KSP.

The monitoring rules described above are merely an example and the present disclosure is not limited thereto. The number of the monitoring rules can be plenty and the establishment of the threshold values for triggering the snapshot can be more complex or flexible. For example, the monitoring rules r with respect to the monitored file F can be established as: when the modification amount of bits exceeds 512 Bytes comparing to the last time point at which the snapshot is established, a new snapshot is established.

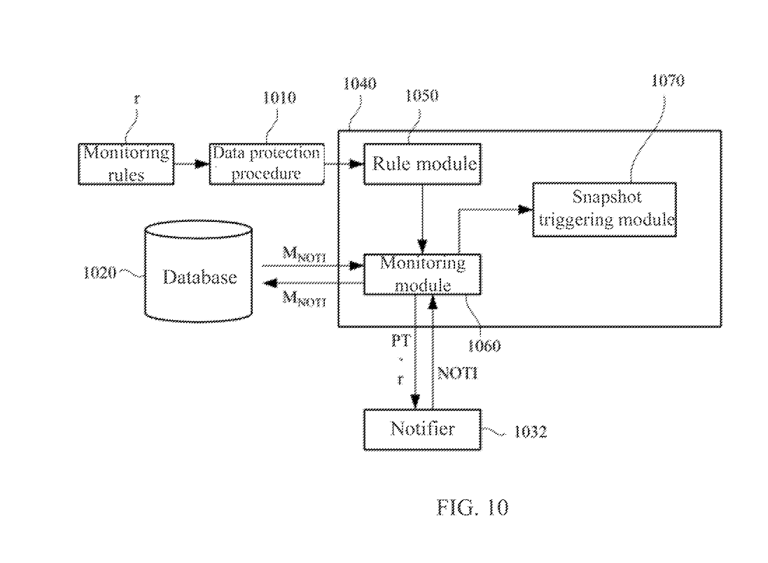

The different examples in the following paragraphs illustrate how the monitoring procedure establishes snapshot according to the monitoring threshold values. Reference is now made to FIG. 10, which is a logic block diagram of the monitoring procedure 1040 according to embodiments of the present disclosure. In an embodiment, the monitoring procedure 1040 can be implemented in the user space USP. However, the present disclosure is not limited thereto. In another embodiment, the monitoring procedure 1040 can be a part of the storage system, e.g. integrated in the storage manager 530 in FIG. 5. In an implementation, the whole monitoring procedure 1040 can be customized to an application-specific hardware circuit or a programmable circuit. As illustrated in FIG. 10, the monitoring procedure 1040 includes a plurality of modules to implement the monitoring of the folders and the function of triggering the snapshot under specific conditions. It is appreciated that though the modules are implemented in a single storage server (e.g. the storage server 120 of FIG. 3) in various embodiments of the present disclosure, the present disclosure is not limited thereto. In some embodiments, the modules can be dispersed among multiple physical devices, and the function of the described modules can be provided through the remote procedure calling service. The program codes related to the modules in the monitoring procedure 1040 can be stored in the computer readable medium, e.g. the compact disk player, the flash memory or the hard disk. Besides, part of the modules can be implemented as an application-specific integrated circuit or a logic circuit.

As illustrated in FIG. 10, the monitoring procedure 1040 may include a rule module 1050, a monitoring module 1060 and a snapshot triggering module 1070. It is appreciated that one or more communication channels can exist between each of the modules to allow the modules exchange data. The rule module 1050 is configured to retrieve the monitoring rules r related to the protected target. According to the monitoring rules r retrieved by the rule module 1050, the monitoring module 1060 can call the notifier 1032 of the file system to perform monitoring on the folder L or the file F in the protected target based on specific categories of rules (e.g. the deletion, the change and the addition of the file, in which the related information can be retrieved from the monitoring rules r). If an change event in the folder L or the file F that matches the monitoring rules r occurs, the notifier 1032 of the file system delivers the notifications NOTI that notify the occurrence of the change event to the monitoring module 1060. The monitoring module 1060 stores the accumulated number MNOTI of the notifications NOTI to the database 1020 until the accumulated number MNOT1 of the notifications NOTI exceeds the defined monitoring threshold values such that the snapshot triggering module 1070 is activated to perform snapshot on the protected target. In an embodiment, the monitoring module 1060 can perform the snapshot on the protected target through the data protection application 1010. In another embodiment, the monitoring module 1060 may have an independent snapshot engine to directly perform the snapshot on the protected target.

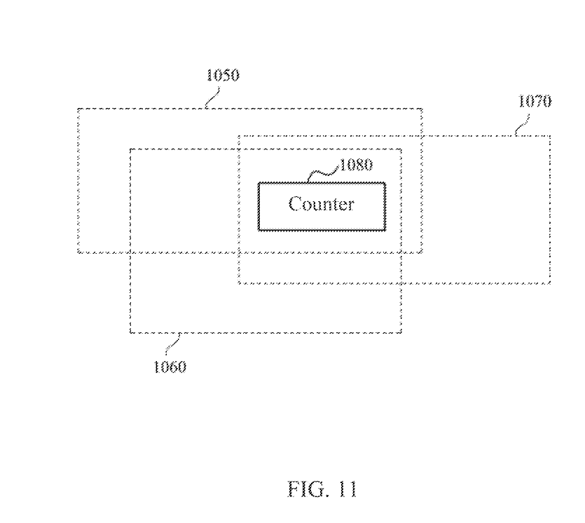

FIG. 11 is a more detailed block diagram that illustrates the rule module 1050, the monitoring module 1060 and the snapshot triggering module 1070 in some embodiments of the present disclosure. The monitoring module 1060 in FIG. 11 further includes a counter 1080. In some embodiments, the counter 1080 is either included in the rule module 1050 or the snapshot triggering module 1070. It is appreciated that the rule module 1050, the monitoring module 1060 and the snapshot triggering module 1070 illustrated in FIG. 11 may include more components or less components that those illustrated in FIG. 11. Besides, each of the modules illustrated in FIG. 11 can be integrated in a single module to be accessed by other application programs.

In some embodiments, the counter 1080 is configured to calculate the times that the file is renamed, the number of the added files, the number of the deleted files and the number of the modified files. When the result of calculation is larger than the monitoring threshold value, the snapshot triggering module 1070 triggers the snapshot function to perform the snapshot on the folder and/or the file in the protected target.

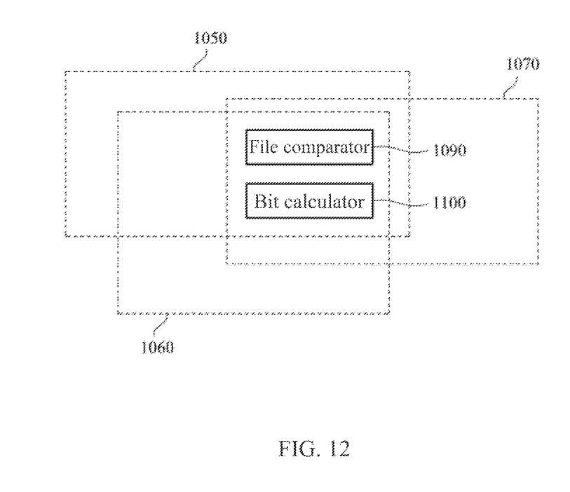

FIG. 12 is a more detailed block diagram that illustrates the rule module 1050, the monitoring module 1060 and the snapshot triggering module 1070 in some embodiments of the present disclosure. The monitoring module 1060 in FIG. 12 further includes a file comparator 1090 and a bit calculator 1100. In some embodiments, the file comparator 1090 and the bit calculator 1100 are either included in the rule module 1050 or the snapshot triggering module 1070. It is appreciated that the functions included in each of the modules illustrated in FIG. 10 to FIG. 12 can be integrated or designed as a multiple of sub-modules according to the practical requirements.

In an embodiment, if the monitoring rule includes monitoring the change of the specific file in the protected target, the bit calculator 100 can calculate the amount of bits of the file upon receiving the file change event. For example, the amount of the change of bits compared to the last change event can be calculated and stored in the database. The file comparator 1090 is configured to determine whether the accumulated amount of changes of the monitored file in the protection target exceeds the monitoring threshold value. When the accumulated amount of changes is larger than the threshold value, the snapshot triggering module 1070 triggers the performing of the snapshot.

Based on the above description, the data protection mechanism in the present disclosure is triggered based on the events. In comparison with the data protection performed based on time, the conditions of establishing the redundant snapshot or the conditions of missing the opportunity to protect important files can be avoided.

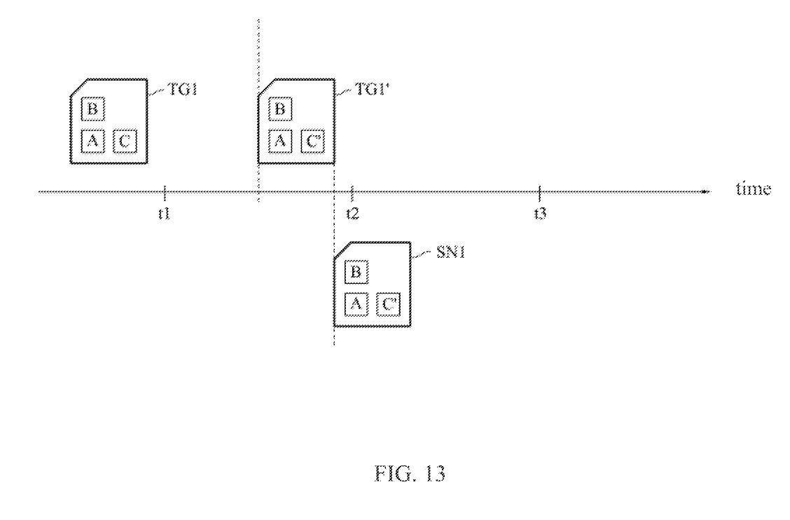

For example, FIG. 13 is a scenario of performing the snapshot on the protected target when using the data protection method of one or more embodiments of the present disclosure. Assuming in FIG. 13, the monitoring rule r for the folder in the protected target is the file C in the target folder TG1 (protected target) being modified once, the snapshot is established. As a result, when the file C is modified into file C′, the target folder TG1 is taken as change folder TG1′ by the storage server (take storage server 400 as an example), and the snapshot SN1 is established. Later at time point t2 and time point t3, the file C′ is not modified, so the redundant snapshot will not be established.

Furthermore, according to the present disclosure, when the protected target encounters larger numbers of change events, the snapshot can be established immediately, so as to protect as least partial data and to reduce data loss. Such larger numbers of change events may be caused by malicious behavior or human mistake.

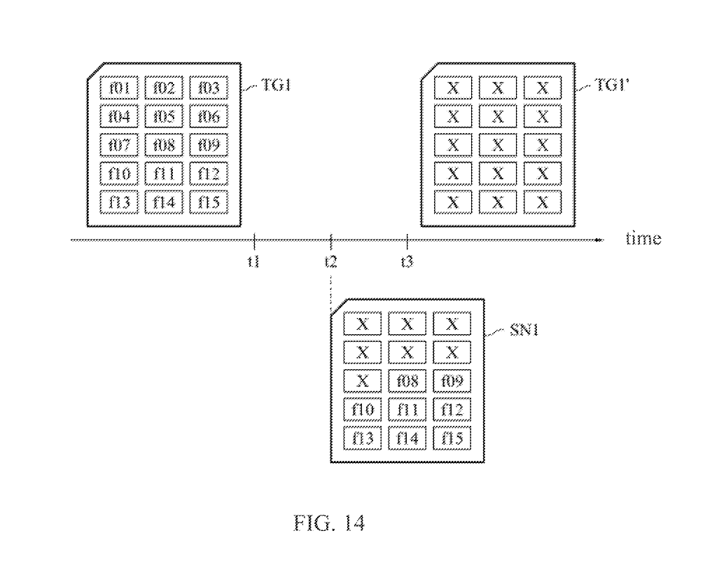

For example, FIG. 14 is another scenario of generating the snapshot for the protected target when applying the data protection method in accordance with one or more embodiments of the present disclosure. In FIG. 14, assuming that the storage server (for example, the storage server 400) is invaded by a malicious encrypted program at the time point t1, then all the protected targets (i.e. the files f01˜f15) are encrypted sequentially. And assuming after the time point t3, the malicious encrypted program finishes the encryption on all the files f01˜f15 (the symbol X is used to represent the encrypted file in FIG. 13), such that all the files f01˜f15 cannot be accessed by the user. In the present example, if the monitoring rule r with respect to the protected target is set up as: the snapshot is established when 7 files in the target folder TG1(the protected target) are modified, then the storage server 400 can immediately establish the snapshot at the time point t2 at which the files f01˜f07 are encrypted. Accordingly, the copies of the files f08˜f015 are established before being encrypted, and the damage can be reduced.

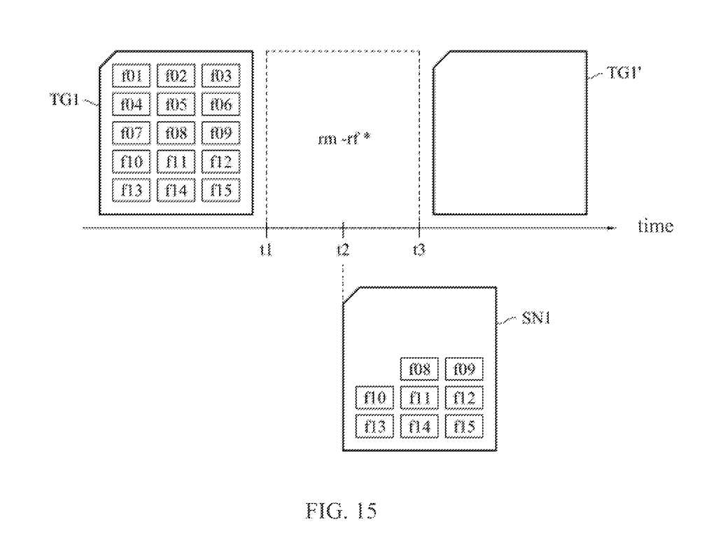

In another example, FIG. 15 is another scenario of performing the snapshot for the protected target when applying the data protection method of one or more embodiments of the present disclosure. In FIG. 15, assuming that the user accidentally inputs a deleting command (e.g. rm-rf*), then the protected targets (all the files f01˜f15 in the target folder TG1) are deleted. And assuming before the time point t3, all the files f01-f15 are deleted sequentially. If the monitoring rule r with respect to the protected target is set up as: the snapshot is established when 7 files in the target folder TG1 (e.g. the files f01˜f07) are deleted. In this situation, the storage server 400 can establish the snapshot SN1 at the time point t2 at which the files f01˜f07 are deleted. The snapshot SN1 includes the copies of 8 files f08˜f15 that are not deleted yet so that the user is allowed to recover the files based on the snapshot.

Based on the above description, according to the data protection method and the storage server of the present disclosure, the data protection mechanism is triggered based on the change event. In comparison with time-based data protection mechanism, the redundant snapshots can be reduced and different monitoring rules with respect to different protected targets are allowed to be established. Furthermore, the snapshot can be instantly established when the large number of change events regarding the protected target are occurred in the data protection method and the storage server, so as to protect at least a part of the data and reduce the data loss. As a result, the flexibility and the security of the data protection can be improved in the present disclosure.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A data protection method used in a storage server, the storage server storing a plurality of data contents, the data protection method comprising:
monitoring a change event of at least one protected target of the data contents;
calculating a modification amount of the change event when the change event matches at least one monitoring rule with respect to the protected target; and
establishing a snapshot of the protected target when the modification amount reaches a monitoring threshold value.

2. The data protection method of claim 1, wherein a system kernel of the storage server comprises at least one kernel monitoring module that corresponds to a plurality monitoring categories, and the monitoring rule is associated with the monitoring categories.

3. The data protection method of claim 1, wherein the protected target is at least one folder, and the monitoring rule comprises adding, deleting, modifying and/or moving a file in the at least one folder.

4. The data protection method of claim 1, wherein when the protected target is at least one file, the monitoring rule comprises modifying a content and/or an attribute of the file.

5. The data protection method of claim 1, further comprising:
calculating an amount of the monitoring rule and determining whether the amount of the monitoring rule exceeds a threshold, and receiving another monitoring rule if the amount of the monitoring rule is less than the threshold.

6. The data protection method of claim 1, further comprising:
determining whether the protected target is monitored by another monitoring procedure such that the monitoring procedure is terminated when the protected target is monitored by the monitoring procedure.

7. The data protection method of claim 1, wherein the modification amount is a modified amount of the bit of the protected target.

8. A storage server, comprising:
a processor configured to execute a monitoring procedure; and
a storage medium configured to store a plurality of data contents and a plurality of instructions such that when the processor executes the instructions, the processor is configured to:
monitoring a change event of at least one protected target of the data contents;
calculating a modification amount of the change event when the change event matches at least one monitoring rule with respect to the protected target; and
establishing a snapshot of the protected target when the modification amount reaches a monitoring threshold value.

9. The storage server of claim 8, wherein a system kernel of the storage server comprises at least one kernel monitoring module that corresponds to a plurality monitoring categories, and the monitoring rule is associated with the monitoring categories.

10. The storage server of claim 8, wherein the protected target is at least one folder, and the monitoring rule comprises adding, deleting, modifying and/or moving a file in the at least one folder.

11. The storage server of claim 8, wherein when the protected target is at least one file, the monitoring rule comprises modifying a content and/or an attribute of the file.

12. The storage server of claim 8, wherein the processor is further configured for:
calculating an amount of the monitoring rule and determining whether the amount of the monitoring rule exceeds a threshold, and receiving another monitoring rule if the amount of the monitoring rule is less than the threshold.

13. The storage server of claim 8, wherein the processor is further configured to:
determining whether the protected target is monitored by another monitoring procedure such that the monitoring procedure is terminated when the protected target is monitored by the monitoring procedure.

14. The storage server of claim 8, wherein the modification amount is a modified amount of the bit of the protected target.
